(19) United States
(12) Patent Application Publication
(10) Pub. No.: US 2025/0281987 A1
(43) Pub. Date: Sep. 11, 2025

(54) METHOD AND SYSTEM FOR GRINDING WORKPIECE

(71) Applicant: HONDA MOTOR CO., LTD., TOKYO (JP)

(72) Inventor: Yu KUBODERA, TOKYO (JP)

(21) Appl. No.: 19/058,202

(22) Filed: Feb. 20, 2025

(30) Foreign Application Priority Data
Mar. 11, 2024 (JP) 2024-036952

(51) Int. Cl. B23F 5/04; B23F 21/02

(52) U.S. Cl. CPC B23F 5/04; B23F 21/026

(57) ABSTRACT

A method for grinding a workpiece includes a first grinding step in which a gear-shaped workpiece and a grinding tool are meshed and rotated, whereby a workpiece tooth surface is ground with a grinding tooth surface, a first correction information generating step in which first correction information is generated by inverting a first deflection waveform, and a second grinding step in which in a state where the workpiece and the grinding tool are meshed and rotated, a rotational speed of the workpiece or the grinding tool is changed based on the first correction information, whereby the workpiece tooth surface is ground with the grinding tooth surface.

### CROSS-REFERENCE TO RELATED APPLICATIONS

This application is based upon and claims the benefit of priority from Japanese Patent Application No. 2024-036952 filed on Mar. 11, 2024, the contents of which are incorporated herein by reference.

### BACKGROUND OF THE INVENTION

### Field of the Invention

The present disclosure relates to a method and a system for grinding a workpiece.

### Description of the Related Art

JP 5467833 B2 discloses a method for grinding a workpiece in which a gear-shaped workpiece and a grinding tool are meshed and rotated to grind a workpiece tooth surface of the workpiece with a helical grinding tooth surface of the grinding tool.

### SUMMARY OF THE INVENTION

A better method and system for grinding a workpiece are long-awaited.

The present disclosure aims to solve the aforementioned problems.

A first aspect of the present disclosure is a method for grinding a workpiece, comprising: a first grinding step in which a gear-shaped workpiece and a grinding tool are meshed and rotated, whereby a workpiece tooth surface is ground with a helical grinding tooth surface of the grinding tool; a first correction information generating step in which first correction information is generated by inverting a first deflection waveform indicating a relationship between a rotational phase of the workpiece and a positional deviation amount of the workpiece tooth surface with respect to the grinding tooth surface during the first grinding step; and a second grinding step in which in a state where the workpiece and the grinding tool are meshed and rotated, a rotational speed of the workpiece or the grinding tool is changed based on the first correction information, whereby the workpiece tooth surface is ground with the grinding tooth surface.

A second aspect of the present disclosure is a grinding system comprising: a grinding control unit configured to perform a first grinding step in which a gear-shaped workpiece and a grinding tool are meshed and rotated, whereby a workpiece tooth surface of the workpiece is ground with a helical grinding tooth surface of the grinding tool; and a correction information generation unit configured to generate first correction information by inverting a first deflection waveform that indicates a relationship between a rotational phase of the workpiece and a positional deviation amount of the workpiece tooth surface with respect to the grinding tooth surface during the first grinding step, wherein the grinding control unit further performs a second grinding step in which in a state where the workpiece and the grinding tool are meshed and rotated, a rotational speed of the workpiece or the grinding tool is changed based on the first correction information, whereby the workpiece tooth surface is ground with the grinding tooth surface.

According to the present disclosure, a better method and system for grinding a workpiece are provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a grinding system according to an embodiment;

FIG. 2 is a control block diagram for the grinding system;

FIG. 3 is a flowchart showing an example of a method for grinding a workpiece;

FIG. 4 is an explanatory diagram for a first correction information generation step;

FIG. 5 is an explanatory diagram for a second correction information generation step; and

FIG. 6 is a graph showing a deflection waveform of a third grinding step.

### DETAILED DESCRIPTION OF THE INVENTION

Gear-shaped workpieces are subjected to heat treatment before the grinding. In this case, a workpiece may deform into an elliptical shape due to thermal strain when viewed from the direction of the rotational axis of the workpiece. Then, there is a possibility that a workpiece tooth surface cannot be ground with good accuracy by a grinding tooth surface. The present disclosure can provide a method and a system for grinding a workpiece that can accurately grind a workpiece tooth surface.

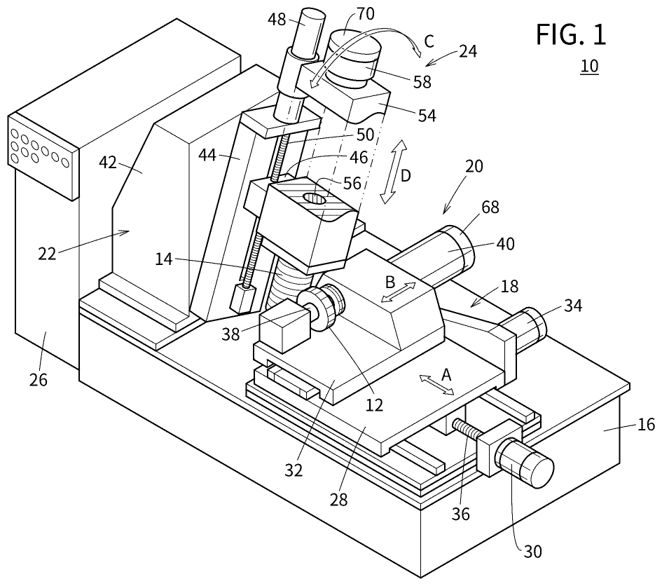

FIG. 1 is a perspective view of a grinding system 10 according to an embodiment. As shown in FIG. 1, the grinding system 10 is a system for grinding a gear-shaped workpiece 12 with a grinding tool 14. The grinding system 10 includes a bed 16, a gear support mechanism 18, a gear rotation mechanism 20, a tool support mechanism 22, a tool rotation mechanism 24, and a controller 26.

The bed 16 is placed, for example, on a horizontal surface of a factory or the like. The gear support mechanism 18 is disposed on a flat upper surface of the bed 16. The gear support mechanism 18 includes a cutting table 28, a cutting motor 30, a traverse table 32, and a traverse motor 34.

The cutting table 28 moves in the A direction with respect to the bed 16. The A direction is a horizontal direction perpendicular to the height direction of the bed 16. The cutting table 28 is connected to the cutting motor 30 via a ball screw shaft 36. The cutting motor 30 moves the cutting table 28 in the A direction by rotating the ball screw shaft 36.

The traverse table 32 is disposed on an upper surface of the cutting table 28. The traverse table 32 moves in the B direction with respect to the cutting table 28. The B direction is a direction perpendicular to the height direction of the bed 16 and the A direction. The traverse table 32 is coupled to the traverse motor 34 via a ball screw shaft (not shown). The traverse motor 34 moves the traverse table 32 in the B direction by rotating the ball screw shaft.

The gear rotation mechanism 20 is arranged on an upper surface of the traverse table 32. The gear rotation mechanism 20 has a gear mounting shaft 38 and a first motor 40. The gear mounting shaft 38 extends in the B direction. The workpiece 12 is attachable to and detachable from the gear mounting shaft 38. The first motor 40 rotates the gear mounting shaft 38.

The tool support mechanism 22 includes a column 42, a pivot table 44, a shift table 46, and a shift motor 48. The column 42 is positioned on the upper surface of the bed 16 so as to face the gear support mechanism 18. The column 42 extends upward from the bed 16. The pivot table 44 is attached to a surface of the column 42 facing the gear support mechanism 18.

The pivot table 44 extends in one direction. A turning motor (not shown) turns the pivot table 44 in the C direction with respect to the column 42. The shift table 46 is provided on a surface of the pivot table 44 facing the gear support mechanism 18. The shift table 46 is coupled to the shift motor 48 via a ball screw shaft 50. The shift motor 48 is attached to the pivot table 44. The shift motor 48 moves the shift table 46 in the D direction with respect to the pivot table 44.

The tool rotation mechanism 24 includes a base 54, a tool mounting shaft 56, and a second motor 58. The base 54 is attached to a surface of the shift table 46 facing the gear support mechanism 18. The base 54 extends along the direction in which the pivot table 44 extends. The tool mounting shaft 56 is inserted through the base 54 along the direction in which the base 54 extends. The grinding tool 14 is attachable to and detachable from the tool mounting shaft 56. The second motor 58 rotates the tool mounting shaft 56.

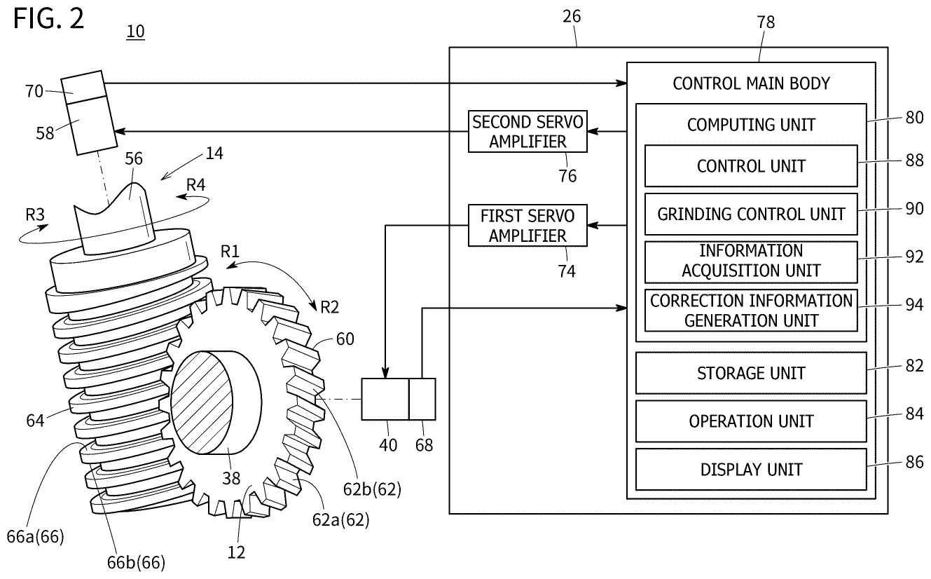

As shown in FIG. 2, the workpiece 12 is mounted on the gear mounting shaft 38. The workpiece 12 can be rotated in the R1 direction and the R2 direction by the driving force of the first motor 40. The workpiece 12 has a plurality of teeth 60. Each of the teeth 60 is formed with a workpiece tooth surface 62. The workpiece tooth surface 62 includes a left workpiece tooth surface 62a and a right workpiece tooth surface 62b.

The grinding tool 14 is mounted on the tool mounting shaft 56. The grinding tool 14 can be rotated in the R3 and R4 directions by the driving force of the second motor 58. The grinding tool 14 is a tool for grinding the workpiece 12. The grinding tool 14 has helical grinding teeth 64. A grinding tooth surface 66 is formed on the grinding teeth 64. The grinding tooth surface 66 includes a first grinding tooth surface 66a and a second grinding tooth surface 66b. For example, single-layer CBN (cubic boron nitride) abrasive grains or the like are electrodeposited on the grinding tooth surface 66 via a nickel plating layer.

When the workpiece 12 is ground by the grinding tool 14, the workpiece 12 and the grinding tool 14 are meshed with each other. With the workpiece 12 and the grinding tool 14 meshed, the left workpiece tooth surface 62a faces the first grinding tooth surface 66a, and the right workpiece tooth surface 62b faces the second grinding tooth surface 66b. With the workpiece 12 and the grinding tool 14 meshed with each other, the workpiece 12 is rotated in the R1 direction and the grinding tool 14 is rotated in the R3 direction, for example, whereby the left workpiece tooth surface 62a can be ground by the first grinding tooth surface 66a and the right workpiece tooth surface 62b can be ground by the second grinding tooth surface 66b. With the workpiece 12 and the grinding tool 14 meshed with each other, the workpiece 12 is rotated in the R2 direction and the grinding tool 14 is rotated in the R4 direction, for example, whereby also the left workpiece tooth surface 62a can be ground by the first grinding tooth surface 66a and the right workpiece tooth surface 62b can be ground by the second grinding tooth surface 66b.

The grinding system 10 further includes a first encoder 68 and a second encoder 70. The first motor 40 is provided with the first encoder 68. The first encoder 68 outputs to the controller 26 information (e.g., pulse signals) on the rotational phase (rotational speed, rotational angle, rotational position, rotational amount) of the workpiece 12.

The second motor 58 is provided with the second encoder 70. The second encoder 70 outputs to the controller 26 information (e.g., pulse signals) on the rotational phase (rotational speed, rotational angle, rotational position, and rotational amount) of the grinding tool 14.

The controller 26 includes a first servo amplifier 74, a second servo amplifier 76, and a control main body 78. The first servo amplifier 74 controls the rotation of the first motor 40 based on signals output from the control main body 78. The second servo amplifier 76 controls the rotation of the second motor 58 based on signals output from the control main body 78.

The control main body 78 includes a computing unit 80, a storage unit 82, an operation unit 84, and a display unit 86. The computing unit 80 is composed of a processor such as a CPU (Central Processing Unit) or a GPU (Graphics Processing Unit). That is, the computing unit 80 is formed by processing circuitry.

The computing unit 80 includes a control unit 88, a grinding control unit 90, an information acquisition unit 92, and a correction information generation unit 94. The control unit 88 controls the cutting motor 30, the traverse motor 34, the turning motor (not shown), and the shift motor 48. The grinding control unit 90 controls the rotation of the workpiece 12 via the first servo amplifier 74. The grinding control unit 90 controls the rotation of the grinding tool 14 via the second servo amplifier 76. The information acquisition unit 92 acquires information output from the first encoder 68 and information output from the second encoder 70. The correction information generation unit 94 generates first correction information 104 and second correction information 110, which will be described later.

The control unit 88, grinding control unit 90, information acquisition unit 92, and correction information generation unit 94 can be realized by the computing unit 80 executing programs stored in the storage unit 82. At least part of the control unit 88, the grinding control unit 90, the information acquisition unit 92, and the correction information generation unit 94 may be realized by an integrated circuit such as an ASIC (Application Specific Integrated Circuit), an FPGA (Field-Programmable Gate Array), or the like. In addition, at least part of the control unit 88, the grinding control unit 90, the information acquisition unit 92, and the correction information generation unit 94 may be configured by an electronic circuit including discrete devices.

The storage unit 82 is composed of a volatile memory (not shown) and a nonvolatile memory (not shown). Examples of the volatile memory include, for example, a RAM (Random Access Memory) or the like. The volatile memory is used as working memory of a processor to temporarily store data or the like required for processing or computing operations. Examples of the nonvolatile memory include, for example, a ROM (Read Only Memory), a flash memory, or the like. The non-volatile memory is used as memory for storage, storing programs, tables, maps, etc. At least part of the storage unit 82 may be provided in the above-described processor, integrated circuit, etc.

The operation unit 84 is used when a user operates the controller 26. The operation unit 84 may include a keyboard, a mouse, and the like. The display unit 86 is provided with a display element (not shown). As the display element, for example, a liquid crystal display element, an organic electroluminescence display element, or the like is used. The operation unit 84 and the display unit 86 may be configured by a touch panel (not shown) provided with such a display element.

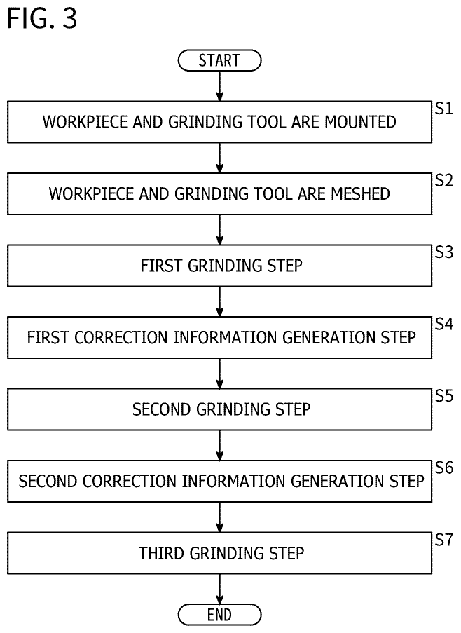

Next, an example of a method for grinding the workpiece 12 will be described. FIG. 3 is a flowchart showing an example of a method for grinding a workpiece 12. The workpiece 12 is subjected to heat treatment before the grinding. In this case, the workpiece 12 may deform into an elliptical shape due to thermal strain when viewed from the direction of the rotational axis of the workpiece 12.

In step S1, the workpiece 12 is mounted on the gear mounting shaft 38 and the grinding tool 14 is mounted on the tool mounting shaft 56. Thereafter, the process transitions to step S2.

In step S2, the workpiece 12 and the grinding tool 14 are meshed with each other. Specifically, the control unit 88 controls the cutting motor 30, the traverse motor 34, the turning motor (not shown), and the shift motor 48 to mesh the workpiece 12 with the grinding tool 14. Thereafter, the process transitions to step S3.

In step S3, a first grinding step is performed. In the first grinding step, the workpiece tooth surface 62 is subjected to rough grinding (first rough grinding). The grinding control unit 90 rotates the workpiece 12 via the first servo amplifier 74 and rotates the grinding tool 14 via the second servo amplifier 76. The grinding control unit 90 rotates the workpiece 12 and the grinding tool 14 synchronously. In other words, the grinding control unit 90 controls the first servo amplifier 74 and the second servo amplifier 76 using feedback in a manner so that the workpiece 12 and the grinding tool 14 rotate maintaining the engaged state, based on the information output from the first encoder 68 and the information output from the second encoder 70.

In the first grinding step, grinding is performed over the circumference of the workpiece 12 (on all the workpiece tooth surfaces 62). If thermal strain has caused deformation in the workpiece 12, deflection of the workpiece tooth surface 62 with respect to the grinding tooth surface 66 can occur in the first grinding step. Thereafter, the process transitions to step S4.

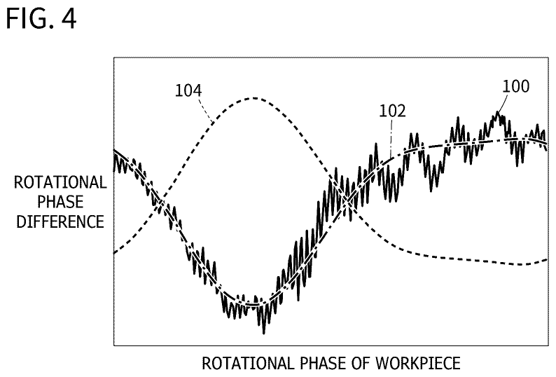

In step S4, a first correction information generation step is performed. FIG. 4 is an explanatory diagram for a first correction information generation step. In FIG. 4, the horizontal axis indicates the rotational phase of the workpiece 12 and the vertical axis indicates the rotational phase difference of the workpiece 12. In the first correction information generation step, the difference (rotational phase difference) between a command value of the rotational phase of the workpiece 12 during the first grinding step and a detected value of the rotational phase of the workpiece 12 is acquired as a positional deviation amount of the workpiece tooth surface 62 with respect to the grinding tooth surface 66. The rotational phase difference of the workpiece 12 indicates a synchronization error in the rotation of the workpiece 12.

As shown in FIG. 4, in the first correction information generation step, the correction information generation unit 94 generates a first deflection waveform 102 by approximating with a sinusoidal wave the deflection waveform 100 that indicates the relationship between the amount of deflection of the workpiece tooth surface 62 with respect to the grinding tooth surface 66 and the rotational phase of the workpiece 12 during the first grinding step. That is, the first deflection waveform 102 indicates the changes in the positional deviation amount of the workpiece tooth surface 62 over one complete lap around the workpiece 12 in the first grinding step. In other words, the first deflection waveform 102 indicates a grinding error in the first grinding step. In the first correction information generation step, the correction information generation unit 94 generates the first correction information 104 by inverting the first deflection waveform 102. The first correction information 104 is information indicating a waveform obtained by inverting the first deflection waveform 102 in the direction of the vertical axis of FIG. 4 (the deflection width direction of the first deflection waveform 102). Thereafter, the process transitions to step S5.

In step S5, a second grinding step is performed. In the second grinding step, the workpiece tooth surface 62 is subjected to rough grinding (second rough grinding). In the second grinding step, while the workpiece 12 and the grinding tool 14 are meshed and rotated, the grinding control unit 90 changes the rotational speed of the workpiece 12 based on the first correction information 104, thereby grinding the workpiece tooth surface 62 with the grinding tooth surface 66. In other words, the grinding control unit 90 outputs to the first servo amplifier 74 the command signal generated based on the first correction information 104 and a synchronous rotation signal of the workpiece 12 and also outputs a synchronous rotation signal of the grinding tool 14 to the second servo amplifier 76, thereby grinding the workpiece tooth surface 62 with the grinding tooth surface 66. That is, in the second grinding step, the grinding control unit 90 controls the rotational speed of the workpiece 12 using feedback so that the grinding error generated in the first grinding step becomes small (a deflection component is corrected).

Thus, in the second grinding step, the grinding error generated in the first grinding step can be reduced. In the second grinding step, in a state where the workpiece 12 and the grinding tool 14 are meshed and rotated, the workpiece tooth surface 62 may be ground with the grinding tooth surface 66 by changing the rotational speed of the grinding tool 14 based on the first correction information 104. Thereafter, the process transitions to step S6.

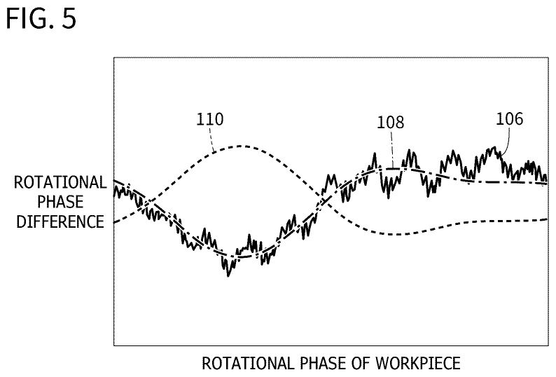

In step S6, a second correction information generation step is performed. FIG. 5 is an explanatory diagram for a second correction information generation step. In FIG. 5, the horizontal axis indicates the rotational phase of the workpiece 12 and the vertical axis indicates the rotational phase difference of the workpiece 12.

As shown in FIG. 5, in the second correction information generation step, the correction information generation unit 94 generates a second deflection waveform 108 by approximating with a sinusoidal wave the deflection waveform 106 that indicates the relationship between the amount of deflection of the workpiece tooth surface 62 with respect to the grinding tooth surface 66 and the rotational phase of the workpiece 12 during the second grinding step. That is, the second deflection waveform 108 indicates the changes in the positional deviation amount of the workpiece tooth surface 62 of the workpiece 12 over one complete lap around the workpiece 12 in the second grinding step. In other words, the second deflection waveform 108 indicates a grinding error in the second grinding step. In the second correction information generation step, the correction information generation unit 94 generates the second correction information 110 by inverting the second deflection waveform 108. The second correction information 110 is information indicating a waveform obtained by inverting the second deflection waveform 108 in the direction of the vertical axis of FIG. 5 (the deflection width direction of the second deflection waveform 108). Thereafter, the process transitions to step S7.

In step S7, a third grinding step is performed. In the third grinding step, the workpiece tooth surface 62 is subjected to finish grinding. In the third grinding step, while the workpiece 12 and the grinding tool 14 are meshed and rotated, the grinding control unit 90 changes the rotational speed of the workpiece 12 based on the second correction information 110, thereby grinding the workpiece tooth surface 62 with the grinding tooth surface 66. In other words, the grinding control unit 90 outputs to the first servo amplifier 74 the command signal generated based on the second correction information 110 and the synchronous rotation signal of the workpiece 12 and also outputs a synchronous rotation signal of the grinding tool 14 to the second servo amplifier 76, thereby grinding the workpiece tooth surface 62 with the grinding tooth surface 66. That is, in the third grinding step, the grinding control unit 90 controls the rotational speed of the workpiece 12 using feedback so that the grinding error generated in the second grinding step becomes small (a deflection component is corrected).

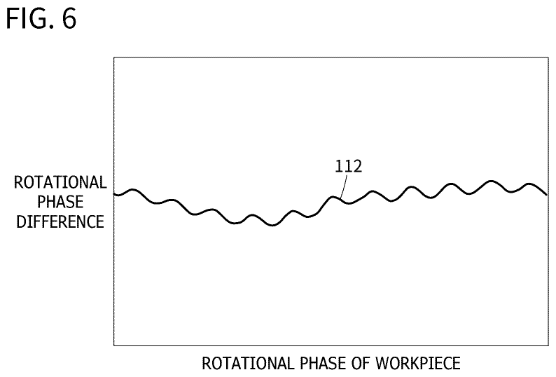

FIG. 6 is a graph showing a deflection waveform 112 of the third grinding step. As shown in FIG. 6, in the third grinding step, the grinding error generated in the second grinding step can be reduced, so that the workpiece tooth surface 62 can be ground with higher accuracy. In the third grinding step, in a state where the workpiece 12 and the grinding tool 14 are meshed and rotated, the workpiece tooth surface 62 may be ground with the grinding tooth surface 66 by changing the rotational speed of the grinding tool 14 based on the second correction information 110. After this, the process of FIG. 3 is completed.

According to the present embodiment, the second grinding step is performed based on the first correction information 104 generated by inverting the first deflection waveform 102 that indicates the relationship between the positional deviation amount of the workpiece tooth surface 62 and the rotational phase of the workpiece 12 during the first grinding step. Thus, in the second grinding step, the grinding error generated in the first grinding step can be reduced. Therefore, the workpiece tooth surface 62 can be ground with high accuracy. Accordingly, a better method and system 10 for grinding the workpiece 12 can be provided.

With respect to the above embodiments, the following supplementary notes are further disclosed.

### Supplementary Note 1

A method for grinding a workpiece of the present disclosure includes: performing first grinding in which a gear-shaped workpiece (12) and a grinding tool (14) are meshed and rotated, whereby a workpiece tooth surface (62) of the workpiece is ground with a helical grinding tooth surface (66) of the grinding tool; generating first correction information (104) by inverting a first deflection waveform (102) that indicates a relationship between a rotational phase of the workpiece and a positional deviation amount of the workpiece tooth surface with respect to the grinding tooth surface during the first grinding; and performing a second grinding in which in a state where the workpiece and the grinding tool are meshed and rotated, a rotational speed of the workpiece or the grinding tool is changed based on the first correction information, whereby the workpiece tooth surface is ground with the grinding tooth surface.

According to such a configuration, the second grinding step is performed based on the first correction information generated by inverting the first deflection waveform indicating the relationship between the positional deviation amount of the workpiece tooth surface and the rotational phase of the workpiece during the first grinding step. Thus, in the second grinding step, the grinding error generated in the first grinding step can be reduced. Therefore, the workpiece tooth surface can be ground with high accuracy. Therefore, a better method for grinding the workpiece can be provided.

### Supplementary Note 2

The method for grinding the workpiece according to Supplementary note 1 may acquire, as the positional deviation amount, a difference between a command value of a rotational phase of the workpiece and a detected value of a rotational phase of the workpiece during the first grinding step in the first correction information generation step.

According to such a configuration, the first correction information can be generated easily.

### Supplementary Note 3

The method for grinding the workpiece according to Supplementary note 1 or 2 may include a second correction information generating step for generating second correction information (110) by inverting a second deflection waveform (108) indicating the relationship between the rotational phase of the workpiece and the positional deviation amount of the workpiece tooth surface with respect to the grinding tooth surface during the second grinding step; and a third grinding step for performing third grinding in which the workpiece tooth surface is ground with the grinding tooth surface by changing the rotational speed of the workpiece or the grinding tool based on the second correction information in a state where the workpiece and the grinding tool are meshed and rotated.

According to such a configuration, the third grinding step is performed based on the second correction information generated by inverting the second deflection waveform that indicates the relationship between the positional deviation amount of the workpiece tooth surface and the rotational phase of the workpiece during the second grinding step. Thus, in the third grinding step, the grinding error generated in the second grinding step can be reduced. Therefore, the grinding tooth surface can be ground with more accuracy.

### Supplementary Note 4

A grinding system (10) of the present disclosure includes a grinding control unit (90) configured to perform a first grinding step in which a gear-shaped workpiece and a grinding tool are meshed and rotated, whereby a workpiece tooth surface of the workpiece is ground with a helical grinding tooth surface of the grinding tool, and a correction information generation unit (94) configured to generate first correction information by inverting a first deflection waveform indicating the relationship between the positional deviation amount of the workpiece tooth surface with respect to the grinding tooth surface and the rotational phase of the workpiece during the first grinding step, wherein the grinding control unit further performs a second grinding step in which the workpiece tooth surface is ground with the grinding tooth surface by changing the rotational speed of the workpiece or the grinding tool based on the first correction information in a state in which the workpiece and the grinding tool are meshed and rotated.

Such a configuration provides the same effect as that of Supplementary note 1. Therefore, it can provide a better grinding system.

### Supplementary Note 5

In the grinding system according to Supplementary note 4, the correction information generation unit may acquire, as the positional deviation amount, a difference between a command value of a rotational phase of the workpiece and a detected value of a rotational phase of the workpiece during the first grinding step.

Such a configuration provides the same effect as that of Supplementary note 2.

### Supplementary Note 6

In the grinding system according to supplementary note 4 or 5, the correction information generation unit may generate the second correction information by inverting a second deflection waveform indicating a relationship between the positional deviation amount of the workpiece tooth surface with respect to the grinding tooth surface and the rotational phase of the workpiece during the second grinding step, and the grinding control unit may further perform a third grinding step of grinding the workpiece tooth surface with the grinding tooth surface by changing the rotational speed of the workpiece or the grinding tool based on the second correction information in a state where the workpiece and the grinding tool are meshed and rotated.

Such a configuration provides the same effect as that of Supplementary note 3.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A method for grinding a workpiece, the method comprising:
performing first grinding in which a gear-shaped workpiece and a grinding tool are meshed and rotated, whereby a workpiece tooth surface of the workpiece is ground with a helical grinding tooth surface of the grinding tool;
generating first correction information by inverting a first deflection waveform that indicates a relationship between a rotational phase of the workpiece and a positional deviation amount of the workpiece tooth surface with respect to the grinding tooth surface during the first grinding; and
performing second grinding in which in a state where the workpiece and the grinding tool are meshed and rotated, a rotational speed of the workpiece or the grinding tool is changed based on the first correction information, whereby the workpiece tooth surface is ground with the grinding tooth surface.

2. The method for grinding the workpiece according to claim 1, wherein
a difference between a command value of the rotational phase of the workpiece and a detected value of the rotational phase of the workpiece during the first grinding is acquired as the positional deviation amount.

3. The method for grinding a workpiece according to claim 1, further comprising
generating second correction information by inverting a second deflection waveform indicating a relationship between a rotational phase of the workpiece and a positional deviation amount of the workpiece tooth surface with respect to the grinding tooth surface during the second grinding, and
performing third grinding in which in the state where the workpiece and the grinding tool are meshed and rotated, the rotational speed of the workpiece or the grinding tool is changed based on the second correction information, whereby the workpiece tooth surface is ground with the grinding tooth surface.

4. A guiding system comprising a controller including one or more processors executing computer-executable instructions stored in memory,
wherein the one or more processors execute the computer-executable instructions to cause the controller to:
perform first grinding in which a gear-shaped workpiece and a grinding tool are meshed and rotated, whereby a workpiece tooth surface of the workpiece is ground with a helical grinding tooth surface of the grinding tool;
generate first correction information by inverting a first deflection waveform that indicates a relationship between a rotational phase of the workpiece and a positional deviation amount of the workpiece tooth surface with respect to the grinding tooth surface during the first grinding; and
perform second grinding in which in a state where the workpiece and the grinding tool are meshed and rotated, a rotational speed of the workpiece or the grinding tool is changed based on the first correction information, whereby the workpiece tooth surface is ground with the grinding tooth surface.

5. The grinding system according to claim 4, wherein
the one or more processors cause the controller to acquire, as the positional deviation amount, a difference between a command value of the rotational phase of the workpiece and a detected value of the rotational phase of the workpiece during the first grinding.

6. The grinding system according to claim 4, wherein
the one or more processors cause the controller to:
generate second correction information by inverting a second deflection waveform that indicates a relationship between a rotational phase of the workpiece and a positional deviation amount of the workpiece tooth surface with respect to the grinding tooth surface during the second grinding, and
perform third grinding in which in the state where the workpiece and the grinding tool are meshed and rotated, the rotational speed of the workpiece or the grinding tool is changed based on the second correction information, whereby the workpiece tooth surface is ground with the grinding tooth surface.
